(19) United States
(12) Patent Application Publication
(10) Pub. No.: US 2005/0198652 A1
(43) Pub. Date: Sep. 8, 2005

(54) Dynamic link library (DLL) for providing server enhancements

(76) Inventors: Anthony A. Huscher, Rocklin, CA (US); Tamra LV. Stark, Loomis, CA (US); Kevin D. Keller, Citrus Heights, CA (US); Troy C. Whitlow, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/757,329

(22) Filed: Jan. 13, 2004

(51) Int. Cl. G06F 3/00; G06F 9/44; G06F 9/46; G06F 13/00; G06F 15/16

(52) U.S. Cl. 719/331; 717/163; 709/203

(57) ABSTRACT

In one embodiment, a method of providing server enhancement, includes: providing a dynamic link library for communicating with a master configuration file to permit changes to at least one editable variable that is associated with an application program. The method may also include: selecting a code line that contains a variable associated with a setting of the application program. The method may also include: replacing the variable in the code line with a new variable associated with a modified setting of the application program. The variables associated with editable settings, of at least one application program, are editable in a single location. In another embodiment, an apparatus for providing server enhancement can perform the above method.

### TECHNICAL FIELD

This disclosure relates generally to server technology, and more particularly to a dynamic link library (DLL) for providing server enhancements.

### BACKGROUND

Web collaboration and e-business solutions may be provided by use of an application known as the eRoom server application (“eRoom”) from DOCUMENTUM, INCORPORATED <www.documentum.com>, 6801 Koll Center Parkway, Pleasanton, Calif. 94566. The eRoom server application is disclosed in, for example, U.S. Pat. No. 6,230,285 to Pito Salas et al. and in U.S. Pat. No. 6,233,600 to Pito Salas et al. The eRoom application can run on the MICROSOFT WINDOWS 2000 server family of products from MICROSOFT CORPORATION. One version of eRoom can be deployed using either a built-in database engine which utilizes SQLAnywhere or deployed using the Microsoft SQL 2000 server or SQL Server 7 database.

The eRoom application has a dynamic link library (DLL) called “eRoomAPI.dll” (also referred to as the “eRoom DLL”). The eRoomAPI.dll is typically stored in an eRoom folder which is a folder in the Microsoft Internet Information Server's INETPUB\SCRIPTS directory. The core of the eRoom application typically installs in the eRoom folder. From the client's perspective, eRoom can be a very thin client that needs a browser to operate, such as Microsoft Internet Explorer 5.0 or newer (4.5 or newer for the Macintosh), or Netscape Navigator 4.08/4.6 or newer.

However, a problem with the eRoomAPI.dll is that the eRoom DLL does not have all of the variables and methods that are needed for custom applications such as, for example, the custom applications provided by HEWLETT-PACKARD COMPANY. The previous approach was to have separate information files for each program. Many of the variables in these separate information files share common information (e.g., the database server name) that can be edited. This meant that if a shared common information (e.g., the database server name) is changed, then all of the separate information files would have to be found and accordingly changed. This requirement leads to increased cost, extra task time, and added inconvenience to users of the eRoom application.

Therefore, the current technology is limited in its capabilities and suffers from at least the above constraints and deficiencies.

### SUMMARY OF EMBODIMENTS OF THE INVENTION

In one embodiment of the invention, a method of providing server enhancement, includes: providing a dynamic link library for communicating with a master configuration file to permit changes to at least one editable variable that is associated with an application program. The method may also include: selecting a code line that contains a variable associated with a setting of the application program. The method may also include: replacing the variable in the code line with a new variable associated with a modified setting of the application program. The variables associated with editable settings, of at least one application program, are editable in a single location.

In another embodiment of the invention, an apparatus for providing server enhancement, includes: a server including a dynamic link library for communicating with a master configuration file to permit changes to at least one editable variable that is associated with an application program.

These and other features of an embodiment of the present invention will be readily apparent to persons of ordinary skill in the art upon reading the entirety of this disclosure, which includes the accompanying drawings and claims.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of an example eRoom environment 100.

FIG. 2 is a block diagram of a system or apparatus that can implement an embodiment of the invention.

FIG. 3 is a block diagram illustrating a method of operation of an embodiment of the invention.

FIG. 4 is a flowchart of method as performed by the DLL in order to change a setting or configuration of a custom application, in accordance with an embodiment of the invention.

FIG. 5 is a flowchart of method as performed by the DLL in order to read a setting or configuration for a custom application, in accordance with an embodiment of the invention.

FIG. 6 is a block diagram illustrating a variable substitution technique, as performed by the DLL of FIG. 2, in accordance with an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments of the invention.

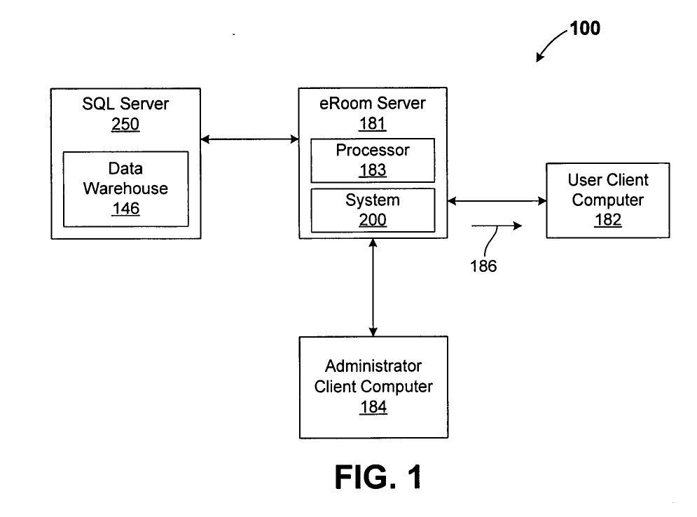

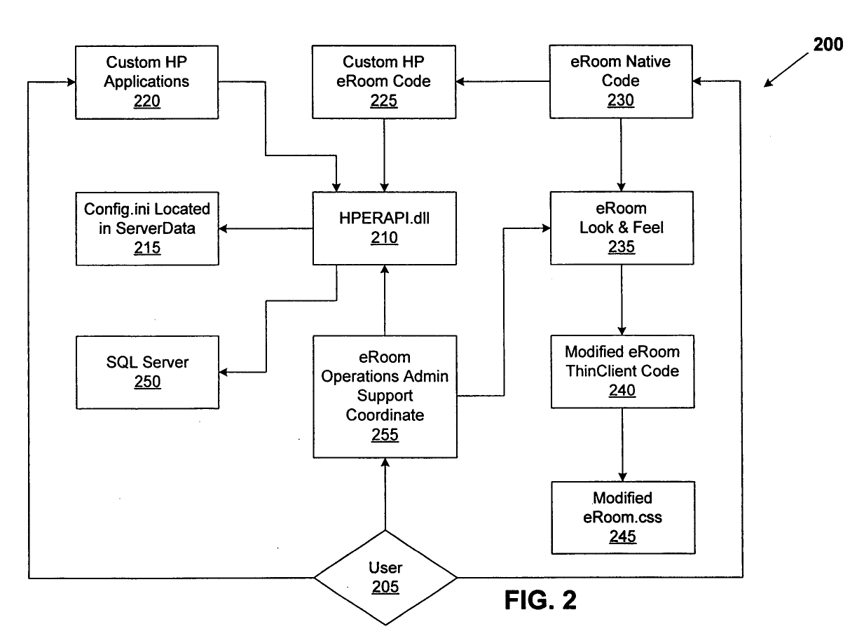

FIG. 1 is a block diagram of an example eRoom environment 100 which includes an eRoom server 181 which can implement the system 200 of FIG. 2, in accordance with an embodiment of the invention. A processor 183 can execute the software or modules in the system 200, to permit various functionalities as described below. The eRoom server 181 typically interacts with the SQL server 250, a user client computer 182, an administrator client computer 184, and/or other client computers. Of course, some of the components in FIG. 1 may be omitted without departing from the scope of embodiments of the invention. The eRoom Server 181 stores a configuration file (config.ini file) 215 to permit settings or functionalities in each eRoom instance to be change by input of variables (e.g., names and/or values) on web pages that are displayed on the administrator client computer 184. Therefore, the config.ini file 215 is on each eRoom instance 100. The components shown in the eRoom environment 180 typically communicate with each other in a local area network (LAN). An eRoom instance is defined as an eRoom environment 100 in FIG. 1.

Reference is now made to FIG. 2, which illustrates a block diagram of a system 200 for server enhancements, in accordance with an embodiment of the invention. The system 200 may be implemented in, for example, one or more servers 181 as similarly shown in the apparatus 100 (eRoom environment 100) of FIG. 1.

An embodiment of the invention permits the administration of the eRoom server application. The eRoom server application, without enhancements, is provided by the eRoom native code 230. Enhancements to the eRoom application are made possible by custom applications 220. Although the examples described below specifically refer to the administration of the eRoom server application, it is within the scope of embodiments of the invention to provide the ability to administer other suitable types of web-collaboration or e-business solution server-based tools.

In an embodiment of the invention, a DLL (dynamic link library) 210 advantageously provides server administrators with the ability to change a number of features in eRoom instances and/or to change features in custom applications 220 that could function with the eRoom application.

A user 205 can input data and receive output information, and interface with various applications such as the eRoom native code 230 and custom applications 220 by use of a DLL 210 in accordance with an embodiment of the invention. Thus, the DLL 210 is an application program interface (API) that can be used for eRoom applications. As known to those skilled in the art, an API is the specific method prescribed by a computer operating system or by an application program by which a programmer writing an application program can make requests to the operating system or another application. As known to those skilled in the art, a DLL is a library of functions that programs can link with dynamically during program execution rather than being compiled with the main program. A DLL contains functions that an executable program can call during execution. A DLL file is often given a “.dll” file name suffix. The set of such files (or the DLL) is somewhat comparable to the library routines provided with programming languages such as C and C++.

The DLL 210 can access a master configuration file (config.ini file) 215 to obtain properties of applications, as well as modify the properties of applications. These applications can include, for example, the custom applications 220.

All of the properties of the user 205 are retained by the DLL 210. The DLL 210 queries the SQL (structured query language) server 250 and this permits the DLL 210 to return a “CreateDate” variable. It is noted that the server 250 is external to the system 200, as shown in FIG. 1, and is shown in FIG. 2 for convenience. The CreateDate( ) field permits information to be pulled from another information field(s) and placed into a data warehouse 146 (see FIG. 1) which is, for example, a database 146 in the SQL server 250. The data warehouse 146 contains all application specific data for the eRoom operations environment 100.

The master configuration file (config.ini file) 215 contains all of the configuration information, setting information, and properties for each application in the custom applications 220. Information in the config.ini file 215 may include one or more of the following: database information (server, username, password, and name); mail information; settings in the custom applications 220; and/or other information.

The custom applications 220 may be, for example, applications for various functionalities provided by Hewlett-Packard Company. The custom applications 220 are typically developed, for example, by use of known software programming techniques. For example, the custom applications 220 can provide one or more of the following functions:
(1) “Forgot Password”—permits an authorized user of the eRoom server 181 (FIG. 1) to obtain a forgotten password.
(2) “User Search”—permits an eRoom administrator to search for authorized users for an eRoom instance 100 (FIG. 1)
(3) “User Aging”—permits an eRoom administrator to automatically manage and remove accounts from an eRoom instance 100.
(5) “Automated eRoom Archive”—permits an eRoom administrator to archive particular accounts in an eRoom instance 100.

The custom eRoom code 225 provides particular functionalities, such as providing notification messages to users of an eRoom instance 100, tracking the failed login attempts of users of an eRoom instance 100, and/or providing settings for look and feel of an eRoom instance 100.

The eRoom Native code 230 is the standard “out-of-the-box” eRoom code (with slight modification by adding Active Server Page (ASP) to the eRoom Native code 230). The eRoom code 230 points to the DLL 210.

The modified eRoom thin client code 240 performs application processing in the system 200.

The eRoom look & feel module 235, modified eRoom thin client code 240, and modified eRoom.css file 245 provide the look and feel functionality for the eRoom application. The colors and fonts appearances are changed in the modified eRoom.css file 245. About four (4) files are changed in the thin client code 240 for the look and feel functionality for an eRoom instance 100.

An eRoom operations web site 255 (as enabled by the eRoom server 181 and eRoom-related codes in FIG. 2) permits settings in an eRoom instance 100 to be modified via the world wide web or other communication network. Therefore, there is no requirement to access the eRoom server 181 to directly modify the config.ini file 215. A user 205 can use the web site 255 to enter changes to at least one editable variable that is associated with an application program and/or to perform various tasks such as, for example, at least one of the following: (1) modify config.ini file 215 to modify settings of an application 220 or to modify other settings in an eRoom instance 100; (2) add notification messages for users of an eRoom instance 100; and/or (3) change look & feel properties in an eRoom instance 100.

The eRoom operations web site 255 provides three different levels of access in order to permit changes to at least one editable variable that is associated with an application program, as provided in currently-available eRoom applications:
(1) An administrator level permits access to all the tools and/or settings in the system 200 that is implemented in each eRoom instance 100;
(2) A support level permits access to a subset of tools and/or settings that can be accessed in the administrator level;
(3) A coordinator level permits access to a smaller subset of tools or settings in the system 200.

The coordinator level typically permits a coordinator to only modify tools or settings in an eRoom(s) which is(are) assigned to the coordinator. Thus, a coordinator is defined as an administrator of a particular eRoom(s). A coordinator can add users or objects in her/his eRoom, create security features in her/his eRoom, and add/delete particular features in her/his eRoom. An “eRoom” is defined as a set of connected private secured collection of hypertext markup language (HTML) pages.

The SQL server 250 stores all errors for the custom application 220. All logging is typically performed in SQL instead of a log file. The SQL server 250 may also provide the notification messages for a user of the eRoom instance 100. The SQL server 250 may include software that uses the DLL 210 to notify users (via the notification messages) of an occurring event(s). A table in the SQL server 320 may be set and modified for displaying the notice or not displaying the notice, a critical or non-critical flag for the notice, a display format for the notice, and/or the time frame for displaying the notice. Examples of notification messages are disclosed in, for example, U.S. patent application Ser. No. 10/408,388, entitled “CONTROL CONSOLE” by Anthony A. Huscher, et al., which is hereby fully incorporated herein by reference.

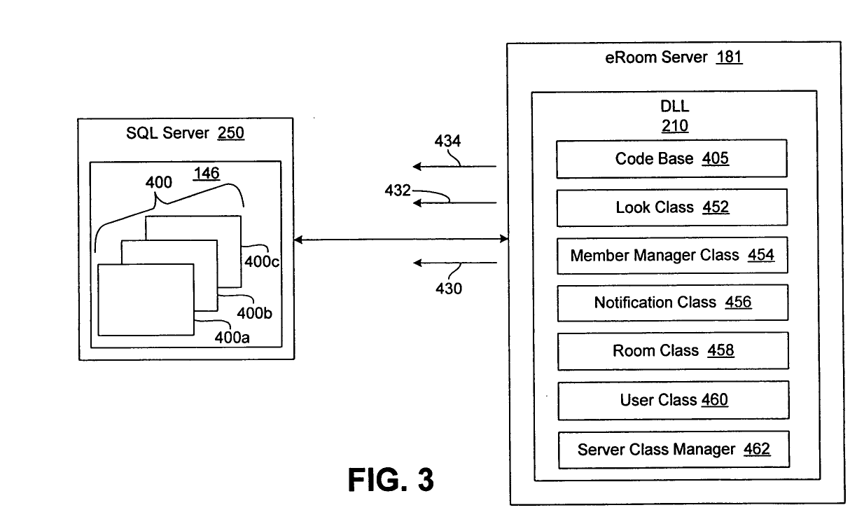

As shown in FIG. 3, each of the custom application 220 has an associated table (generally tables 400 which are contained in the data warehouse 146 in the SQL server 250). For example, tables 400a, 400b, and 400c, are each associated with a particular custom application 220. In one embodiment, these tables are contents in the data warehouse 146. These tables 400 provide configuration information associated with settings in the custom applications 220, and the configuration information can be queried and modified by the DLL 210.

In an embodiment, the DLL 210 contains an internal code base which permits the operations as described below.

The DLL 210 holds class codes 452-460, where each class code contains properties or configuration information of custom applications 220. It is noted that the number of class codes may vary. All the class codes are in the DLL ( 210 ) which is registered on each of the eRoom instances 100. The class codes 452-460 and DLL code base 405 are typically developed, for example, by use of known software programming techniques.

In an embodiment, the DLL 210 provides the various class codes that are used, depending on the particular setting that is being modified or read from the config.ini file 215. For example, the look & feel class code 452 (FIG. 3) permits a variable(s) associated with look & feel settings (e.g., background, colors, fonts, format, and/or other properties) in an eRoom instance 100 to be called and/or replaced in the config.ini file 215.

The member manager class 454 (FIG. 3) permits a variable(s) (associated with LDAP (Lightweight Directory Access Protocol) server compatibility with the eRoom application) to be called and/or replaced in the config.ini file 215.

The notification class 456 (FIG. 3) permits a variable(s) associated with notification messages to user accounts in the eRoom instance 100 to be called and/or replaced in the config.ini file 215.

The room class 458 (FIG. 3) permits a variable(s) associated with eRooms in the eRoom instance 100 to be called and/or replaced in the config.ini file 215.

The user class 460 (FIG. 3) permits a variable(s) associated with users in the eRoom instance 100 to be called and/or replaced in the config.ini file 215.

The server manager class 462 (FIG. 3) permits a variable(s) associated with the management of eRoom server 183 in the eRoom instance 100 to be called and/or replaced in the config.ini file 215.

Other code classes may be created in order to permit modifications of variables associated with other settings in an eRoom instance 100.

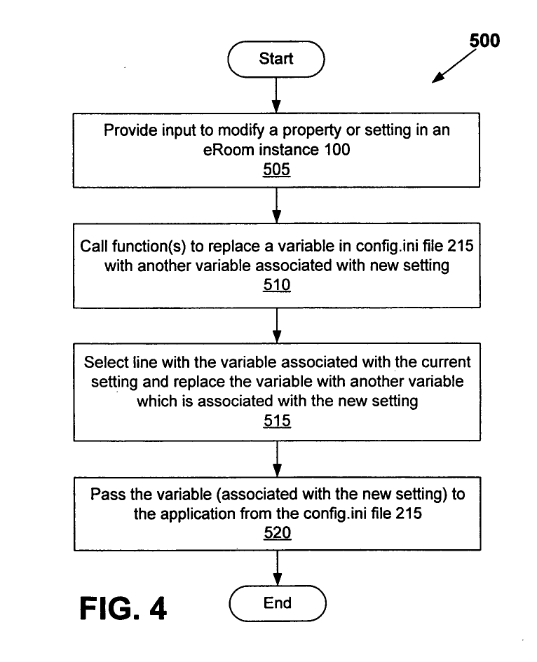

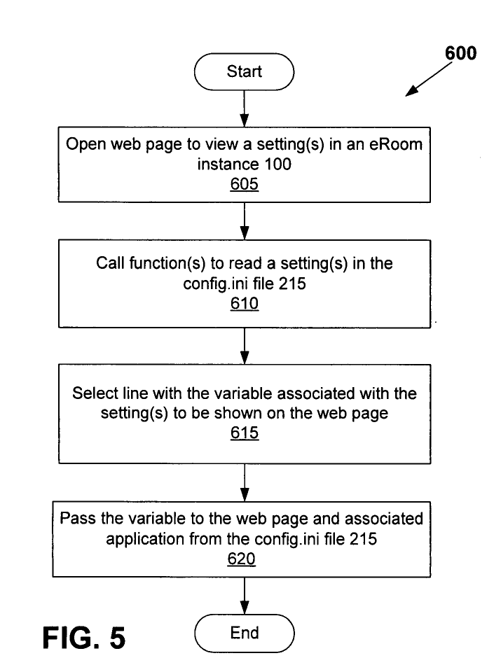

Reference is now made to FIGS. 4-6 to describe a method of changing configuration data related to a custom application 220 by use of the DLL 210, in accordance with an embodiment of the invention. FIG. 4 is a flowchart of method 500 as performed by the DLL 210 in order to change a setting or configuration of a custom application 210, in accordance with an embodiment of the invention. FIG. 5 is a flowchart of method 600 as performed by the DLL 210 in order to read a setting or configuration for a custom application 210, in accordance with an embodiment of the invention.

The method 500 (FIG. 4) begins with the user 205 providing (505) input to modify a property or setting in an eRoom instance 100. To modify a setting in an eRoom instance, a setting in a custom application 220 may be modified. The user 205 inputs the desired modifications of the settings by use of the website 255 (FIG. 2). As an option to authenticate the user who is providing input to modify a setting, an internal code base 405 (in the DLL 210) first determines if the user is an authorized user and passes an SQL statement indicating a query to the user. After the user is authenticated, the method 500 proceeds to step (505) as discussed below.

The DLL 210 calls (510) a function(s) to replace a variable (or variable string) in the config.ini file 215 with another variable (or variable string) associated with the new setting. As shown in step (515), the function 430 (FIG. 3) selects a line with the variable associated with the current setting, and the function 432 (FIG. 3) replaces the variable with the new variable which is associated with the new setting.

In step (520), the function 434 permits the DLL to obtain the new variable (associated with new setting) from the config.ini file 215 and to pass the new variable to the application associated with the setting.

FIG. 5 is a block diagram of a method 600 to read a variable associated with a setting, in accordance with an embodiment of the invention. The method 600 begins with the user 205 opening a web page (605) in the website 255 (FIG. 2) in order to view a setting(s) in an eRoom instance 100. As an option to authenticate the user who will open the web page, an internal code base 405 (in the DLL 210) first determines if the user is an authorized user and passes an SQL statement indicating a query to the user. After the user is authenticated, the method 600 proceeds to step (605) to open the web page.

The DLL 210 calls (610) a function(s) to read a setting(s) in the config.ini file 215, where the setting is displayed on the web page. As shown in step (615), the function 430 (FIG. 3) selects a line with the variable associated with the setting to be shown on the web page.

In step (620), the function 434 permits the DLL to obtain the variable from the config.ini file 215 and to pass the variable to the application associated with the setting and to pass the variable to the web page in order to display the settings on the web page.

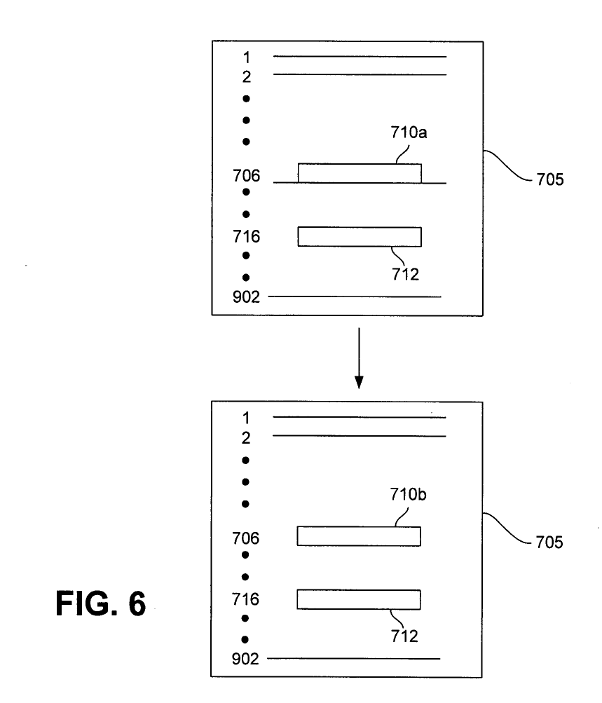

FIG. 6 is a block diagram of a code 705 associated with particular settings, as stored in a config.ini file 215. The DLL function 430 will open a file with the code 705, and will check the lines in the code 705 until the function 430 finds the line with the variable associated with a setting to be read and/or modified in an eRoom instance 100. The DLL 210 is coded to look for a config.ini file 215 in the directory that the DLL 210 is registered in.

In the example of FIG. 6, assume that the line 706 contains the variable (or variable string) 710 a that is associated with an editable setting for an application/program in the custom applications 220. Thus, the editable setting may be read and/or modified to change a configuration in an eRoom instance 100, for example. The variables may be, for example, alphanumeric text and/or numerical text. The variable 710 a is typically a setting that can be edited. For example, assume that one of the custom application 220 is a notification manager application that provides notifications 186 (FIG. 1) to users of the eRoom instance 100. The notifications may be displayed in one or more user client computer 182 (FIG. 1) by the notification manager application to notify the user about a particular event or condition. The variable 710 a (FIG. 6) may be, for example, an editable variable that indicates the text content of the notification. As another example, a variable 712 (in line 716) may indicate the time schedule when a notification 186 is sent to the users or indicate the critical notifications and non-critical notifications. Other lines in the code 702 may contain other editable variables that adjust the editable settings for the notification manager. The DLL 210 permits the user 205 to modify the editable settings (via website 255) for particular applications, such as custom applications 220 in the eRoom instance 100.

Other codes (not shown in FIG. 6) may be stored in the config.ini file 215, where the codes include other editable variables (or variable strings) that determines the editable settings or configurations for other applications in the custom applications 220 or for other code in the system 200 (FIG. 2).

In an embodiment, the internal code base 405 (FIG. 3) defines the technique for searching for a line with a particular editable variable. As an example, as shown in Table 1, the following code text which identifies particular editable variables. Numeral “114” identifies an editable variable of permitting the display of a critical message to an eRoom instance 100. Numeral “115” identifies an editable variable of permitting the display of a particular message. Numeral “116” identifies an editable variable of permitting the display of an error message to a user. The DLL 210 can search the numerals 114, 115, and 116 in the config.ini file 215 to identify these particular variables and to perform any edits to these editable variables to change particular settings of applications in the eRoom instance 100.

TABLE 1

Case 114: strSearchFor = “Display Critical Message In Rooms”
Case 115: strSearchFor = “Map Message”
Case 116: strSearchFor = “Error Email Address”

A function named GetConfigValue in the DLL 210 performs a select case control structure to check for a particular text string that matches the variable name that is passed to the function. Once the particular string is found, a search sting variable is assigned for that particular variable name found. The config.ini file 215 is then read in from the file system (in eRoom server 181) and parsed into an array and then searched for that assigned variable. That variable is returned for use by an application that needs to use the variable.

The DLL function 432 then replaces the variable 710 a with new variable (or new variable string) 710b which is associated with the modified settings for an eRoom instance 100. A function named SetConfigValue in the DLL 215 performs a select case control structure to check for a particular text string that matches the variable name that is passed to the function. Once the particular string is found a search string variable is assigned for that particular variable name found. The config.ini file 215 is then read in from the file system and parsed into an array and then searched for that assigned variable. Once found the function writes the new variable value the config.ini file.

The DLL function 434 then passes the new variable 710b from the config.ini file 215 to the application that use the setting associated with the new variable 710b. The new variable 710b is typically passed as a string to the application. An application can call the GetConfigValue function from the DLL 210 which allows the application the ability to obtain the setting value for a specific action.

The various engines or tools discussed herein may be, for example, software, commands, data files, programs, code, modules, instructions, or the like, and may also include suitable mechanisms.

Reference throughout this specification to “one embodiment”, “an embodiment”, or “a specific embodiment” means that a particular feature, structure, or characteristic described in connection with the embodiment is included in at least one embodiment of the present invention. Thus, the appearances of the phrases “in one embodiment”, “in an embodiment”, or “in a specific embodiment” in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing teaching.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

It is also within the scope of the present invention to implement a program or code that can be stored in a machine-readable medium to permit a computer to perform any of the methods described above.

Additionally, the signal arrows in the drawings/Figures are considered as exemplary and are not limiting, unless otherwise specifically noted. Furthermore, the term “or” as used in this disclosure is generally intended to mean “and/or” unless otherwise indicated. Combinations of components or actions will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method of providing server enhancement, the method comprising:
providing a dynamic link library for communicating with a master configuration file to permit changes to at least one editable variable that is associated with an application program.

2. The method of claim 1, further comprising:
selecting a code line that contains a variable associated with a setting of the application program.

3. The method of claim 2, further comprising:
replacing the variable in the code line with a new variable associated with a modified setting of the application program.

4. The method of claim 1, wherein the variables associated with editable settings, of at least one application programs, are editable in a single location.

5. The method of claim 1, further comprising:
passing a modified variable to the application program.

6. The method of claim 1, wherein the dynamic link library is configured to permit input of data and output of information, and interface with various applications.

7. The method of claim 7, wherein one of the various applications permits an administrator to automatically manage and remove accounts from an eRoom instance.

8. The method of claim 1, further comprising:
using a website to enter changes to at least one editable variable that is associated with an application program.

9. The method of claim 1, further comprising:
providing different levels of access in order to permit changes to at least one editable variable that is associated with an application program.

10. An apparatus for providing server enhancement, the apparatus comprising:
a server including a dynamic link library for communicating with a master configuration file to permit changes to at least one editable variable that is associated with an application program.

11. The apparatus of claim 10, wherein the dynamic link library is configured to select a code line that contains a variable associated with a setting of the application program.

12. The apparatus of claim 11, wherein the dynamic link library is configured to replace the variable in the code line with a new variable associated with a modified setting of the application program.

13. The apparatus of claim 10, wherein the variables associated with editable settings, of at least one application programs, are editable in a single location.

14. The apparatus of claim 10, wherein the dynamic link library is configured to pass a modified variable to the application program.

15. The apparatus of claim 10, wherein the dynamic link library is configured to permit input of data and output of information, and interface with various applications.

16. The apparatus of claim 15, wherein one of the various applications permits an administrator to automatically manage and remove accounts from an eRoom instance.

17. The apparatus of claim 10, wherein the dynamic link library is configured to receive a user-entered change from a website, where the user-entered change is associated with an application program.

18. The apparatus of claim 10, wherein the dynamic link library is configured to proved different levels of access in order to permit changes to at least one editable variable that is associated with an application program.

19. An apparatus for providing server enhancement, the apparatus comprising:
means for providing a dynamic link library for communicating with a master configuration file to permit changes to at least one editable variable that is associated with an application program.

20. An article of manufacture, comprising:
a machine-readable medium having stored thereon instructions to:
provide a dynamic link library for communicating with a master configuration file to permit changes to at least one editable variable that is associated with an application program.
